(19) United States
(12) Patent Application Publication
(10) Pub. No.: US 2025/0026639 A1
(43) Pub. Date: Jan. 23, 2025

(54) EFFECTIVE USE OF CRYOGENIC SEPARATION SECTION IN SYNGAS MANUFACTURE

(71) Applicant: Topsoe A/S, Kgs. Lyngby (DK)

(72) Inventors: Peter Mølgaard MORTENSEN, Kgs. Lyngby (DK); Steffen Spangsberg CHRISTENSEN, Kgs. Lyngby (DK)

(73) Assignee: Topsoe A/S, Kgs. Lyngby (DK)

(21) Appl. No.: 18/708,585

(22) PCT Filed: Jan. 23, 2023
(86) PCT No.: PCT/EP2023/051564

§ 371 Date: May 8, 2024

(30) Foreign Application Priority Data
Jan. 24, 2022 (EP) 22152989.4

(51) Int. Cl. C01B 3/50; B01D 53/00; B01D 53/26; C01B 3/36; C01B 3/38; C01C 1/04; F25J 3/04

(52) U.S. Cl. CPC C01B 3/506; B01D 53/002; B01D 53/26; C01B 3/36; C01B 3/38; C01C 1/04; F25J 3/04539; F25J 3/04563; B01D 2256/12; B01D 2256/16; B01D 2257/102; B01D 2257/504; B01D 2257/80; B01D 2258/06; C01B 2203/0227; C01B 2203/025; C01B 2203/046; C01B 2203/068; C01B 2203/0883; C01B 2203/1235

(57) ABSTRACT

A chemical plant is provided which comprises an air separation section (ASU), a reformer section, a water-removal section and a refrigerated separation section. A first feed of atmospheric air is separated in the ASU to produce a refrigerant stream. A hydrocarbon feed is converted to a first syngas stream in the reformer section. Water is removed from the first syngas stream and at least a portion of the resulting dried first syngas stream is separated it into at least a product stream, and a by-product stream; by means of the refrigerated separation section. Importantly, the refrigerated separation section is cooled by a refrigerant stream (e.g., nitrogen) from the ASU. A process for producing a product stream, using the plant, is also provided.

### TECHNICAL FIELD

The present invention relates to a chemical plant and process in which an air separation section (ASU) provides oxygen for a reformer section in reforming a hydrocarbon feed, as well as a stream comprising a refrigerant (e.g., nitrogen), which may be used to cool other components of the plant or steps in the process. The present invention describes how a synergy can be achieved between several cryogenic units or process steps operating within the same general chemical plant/process.

### BACKGROUND

Cryogenic separation processes are typically driven by the Joule-Thomsen effect. This means essentially that-at a given temperature and pressure-expansion of a gas or liquid results in cooling of the medium. Like in a refrigerator, this means that cooling can be achieved by first compressing a gas and subsequently expanding it.

In the chemical industry, cryogenic processes are used to a large extent for separation processes, typical examples being air separation sections and CO cold boxes. These units have classically been operated as independent units, where their battery limit interface is close to ambient conditions.

Cryogenic plants are today designed as standalone units, where cooling inside the unit is supplied by a dedicated compressor. In a CO cold box, cooling is provided by recycling CO in large amounts, while CO2 separation is driven by expanding the CO2 product. Cryogenic separation processes can also be expensive and resource-intensive, because large compressors are needed to drive the cooling mechanism in the separation sections. Known technology includes US2013/0111948 A1.

There is a need for improved chemical plants and processes, in which the potential for synergy between the various units, including an Air Separation section (ASU) is optimised.

### SUMMARY

It has been found by the present inventor(s) that cooling capacity can be extracted from a single unit, specifically the ASU, and then used to drive other cryogenic process. This allows for using fewer compressors in such a plant, which thereby also makes the operation of the individual compressors more efficient. Accordingly, the present technology provides a plant according to independent claims 1 and 17, and a process according to independent claim 14.

Further details of the technology are provided in the enclosed dependent claims, figures, and examples.

### LEGENDS TO THE FIGURES

The technology is illustrated by means of the following schematic illustrations, in which:

FIG. 1 shows a basic layout of the plant of the invention.

FIG. 2 development of the embodiment of FIG. 1.

FIG. 3 is a development of the embodiment of FIG. 2, including nitrogen wash unit and ammonia loop.

### DETAILED DISCLOSURE

Unless otherwise specified, any given percentages for gas content are % by volume. All feeds are preheated as required.

The term “synthesis gas” (abbreviated to “syngas”) is meant to denote a gas comprising hydrogen, carbon monoxide, carbon dioxide and small amounts of other gasses, such as argon, nitrogen, methane, etc.

The current concept describes a method to move all cooling generation to an ASU, which enables cooling of one or more processes in the syngas preparation step. The requirement for cryogenic separation equipment is reduced by moving the cooling duty more or less dedicated to a single compressor inside the ASU. This also increases the reliability of the process, as rotating equipment (such as a compressor) typically requires service and back-up plans to ensure stable operation of a chemical plant.

The present invention describes how a synergy can be achieved between several cryogenic processes operating within the same chemical facility. Specifically, byproduct of nitrogen rich cold gas/liquid from an ASU is produced and used to drive other cooling processes. Liquid nitrogen has a boiling point of −196°° C., which makes this a suitable medium to cool e.g., a CO cold box, which typically operates at ca. −180° C. Also, a CO₂ separation section can be driven in the same manner, as this typically operates around −100° C.

A chemical plant is thus provided, which comprises:
a cryogenic air separation section (ASU),
a reformer section, and
a water-removal section
a refrigerated separation section
a first feed of atmospheric air,
a hydrocarbon feed.

These components, and their relationship, will be discussed in the following text.

### Feeds

A first feed of atmospheric air is provided to the chemical plant; more specifically to the ASU. In a preferred embodiment, said atmospheric is sucked from surrounding atmosphere of said ASU. Said atmospheric air will typically contain at least 75-80% nitrogen and 15-25% oxygen, while other constituents such as CO₂, Ar, and He also may be present. Typical temperature will be from −25 to +50° C., while typical pressure will be 0.9 to 1.1 atm.

A hydrocarbon feed is provided to the reformer section. In this context, the term “hydrocarbon feed” is meant to denote a gas with one or more hydrocarbons and possibly other constituents. Thus, typically hydrocarbon feed comprises a hydrocarbon gas, such as CH₄ and optionally also higher hydrocarbons often in relatively small amounts, in addition to various amounts of other gasses. Higher hydrocarbons are components with two or more carbon atoms such as ethane and propane. Examples of “hydrocarbon gas” may be natural gas, town gas, naphtha or a mixture of methane and higher hydrocarbons, biogas or LPG. Hydrocarbons may also be components with other atoms than carbon and hydrogen such as oxygenates. The hydrocarbon feed may also include other constituents, such as carbon monoxide, carbon dioxide, nitrogen and argon in trace amounts (e.g., below 2%).

### Cryogenic Air Separation Section (ASU)

The cryogenic air separation section (also called an “air separation unit, ASU”) is arranged to receive said first feed of atmospheric air and produce a second stream comprising oxygen and a third refrigerant stream. The third refrigerant stream is preferably a nitrogen stream. The ASU functions via distillation. The ASU may comprise a single distillation column operating at elevated pressure, or more than one distillation column, each column operating at different elevated pressures.

In preferred embodiments, the ASU comprises either a dual column arrangement comprising a higher pressure column and a lower pressure column in which the columns are thermally integrated by a reboiler/condenser, or a tri-column arrangement comprising a higher pressure column, an intermediate pressure column and a lower pressure column in which the higher pressure column is thermally integrated with the lower pressure column by a first reboiler/condenser, and the intermediate pressure column is thermally integrated with the lower pressure column via a second reboiler condenser. The operating pressure of the higher-pressure column is usually from about 3 bar to about 12 bar (0.3 to 1.2 MPa). The operating pressure of the lower pressure column is usually from about 1.1 bar to about 5 bar (0.11 to 0.5 MPa). The operating pressure of an intermediate pressure column is usually from about (1.8 bar to about 8 bar (0.18 to 0.8 MPa).

In an embodiment, said third refrigerant stream is substantially pure nitrogen at a temperature of −195 to −170° C. at a pressure of 0.1 to 50 barg. In an embodiment, said third refrigerant stream is substantially pure oxygen at a temperature of −195 to −170° C. at a pressure of 0.1 to 50 barg.

### Reformer Section

A reformer section is arranged to receive at least a portion of the hydrocarbon feed and convert this to a first syngas stream. Suitably, the reformer section is also arranged to receive at least a portion of the second stream comprising oxygen and the hydrocarbon feed and convert them to a first syngas stream. A feed of steam, and potentially also a feed of CO2, may also be provided to the reformer section.

The reformer section typically has a feed side and a fired side and is arranged to receive the hydrocarbon feed. The “feed side” is the side of the reformer section that receives the hydrocarbon feed. The “fired side” is the side of the reformer section that creates elevated temperatures used to facilitate as least part of the reforming process.

The reformer section converts the hydrocarbon feed to a stream of syngas in the feed side of the reformer section. The reformer section suitably comprises at least one primary reforming unit(s), being selected from a steam methane reforming (SMR) unit, an autothermal reforming (ATR) unit, a convective reforming unit or a two-step reforming unit, preferably an ATR unit. In the case of an SMR the “feed side” of the reformer section is understood as the feed to the catalyst in the tubular reactors, and the “fired side” is understood as the burners placed in the combustion chamber surrounding the tubular reactors. In the case of an ATR the “feed side” of the reformer section is understood as the feed to the catalyst in ATR, and the “fired side” is understood as a fired heater.

The reformer section suitably comprises one or more primary reformers selected from a steam methane reforming (SMR) reactor, an e-SMR and an autothermal reforming (ATR) reactor. The process is specifically advantageous in the case where the reformer section includes an ATR, because this reactor may use the oxygen product from the ASU. In this way, synergy between all primary components of the plant can be achieved.

The reformer section may comprise a primary reformer and a shift conversion unit arranged downstream the primary reformer. The shift conversion unit changes the makeup of the first syngas stream, such that the required e.g., H₂/CO ratio can be obtained.

In another preferred embodiment, the reformer section comprises an electrical steam methane reformer (e-SMR).

Details of suitable reformer units and their operation are known in the field and need not be discussed in further detail.

### Water-Removal Section

The water-removal section is arranged to receive at least a portion of the first syngas stream and provide a water-rich stream and a dried first syngas stream. In an embodiment, the water removal section is selected from the group consisting of a flash separation unit, a pressure swing adsorption (PSA) unit, a temperature swing adsorption (TSA) unit, or a combination thereof.

In an embodiment, the water separation section of the plant is a flash separation unit. The flash separation unit is often preceded by suitable temperature reduction equipment. By flash separation is meant a phase separation unit, where a stream is divided into a liquid and gas phase close to or at the thermodynamic phase equilibrium at a given temperature.

In an embodiment, the water separation section of the plant is a pressure swing adsorption unit (PSA unit) or a temperature swing adsorption unit (TSA unit). By swing adsorption, a unit for adsorbing selected compounds is meant. In this type of equipment, a dynamic equilibrium between adsorption and desorption of gas molecules over an adsorption material is established. The adsorption of the gas molecules can be caused by steric, kinetic, or equilibrium effects. The exact mechanism will be determined by the used adsorbent and the equilibrium saturation will be dependent on temperature and pressure. Typically, the adsorbent material is treated in the mixed gas until near saturation of the heaviest compounds and will subsequently need regeneration. The regeneration can be done by changing pressure or temperature. In practice, this means that a process with at least two units is used, saturating the adsorbent at high pressure or low temperature initially in one unit, and then switching unit, now desorbing the adsorbed molecules from the same unit by decreasing the pressure or increasing the temperature. When the unit operates with changing pressures, it is called a pressure swing adsorption unit, and when the unit operates with changing temperature, it is called a temperature swing adsorption unit.

### Refrigerated Separation Section

The refrigerated separation section is arranged to receive at least a portion of the dried first syngas stream and separate it into at least a product stream, and a by-product stream. Typically, the by-product stream is either a CO-rich stream or a CO₂-rich stream. The type of refrigerated separation section determines whether a CO-rich stream or a CO₂-rich stream is obtained alongside the product stream.

Importantly, the refrigerated separation section is cooled by at least a portion of the third refrigerant stream from the ASU. In this manner, the output of cold nitrogen-rich gas/liquid from the ASU can be used to drive other cooling processes in the plant/process.

The refrigerant from the ASU is suitably nitrogen. In an embodiment the refrigerant is substantially pure oxygen. In another embodiment the refrigerant is a mixture of nitrogen and oxygen.

The refrigerated separation section may comprise a CO cold box and/or a cryogenic CO₂ separation section.

In one embodiment, the refrigerated separation section comprises a CO cold box, the by-product stream is a CO-rich stream, and the product stream is a H₂-rich stream. In this embodiment, the plant/process comprises an ASU, a reformer section, and a separation with a CO cold box. In this case, the CO cold box is arranged to be cooled by the refrigerant stream from the ASU. In this way any CO recycle compressor can be significantly reduced in size, and potentially completely removed.

A CO cold box typically comprises (in order)
i. a methane wash unit;
ii. a hydrogen stripper unit, and;
iii. a CO/CH₄ separation section.

The methane wash unit is arranged to receive a stream of syngas from the reforming section and separate it into at least an H₂-rich stream and a H₂-depleted second gas stream. The syngas stream from the reforming section may be the stream obtained from the primary reforming unit, or its chemical make-up may be amended (e.g. via the least one additional units described above) to provide an alternative syngas stream.

The hydrogen stripper unit is arranged to receive the H₂-depleted second gas stream from the methane wash unit and separate it into at least an intermediate stream and an off-gas stream. The hydrogen stripper unit uses low temperature liquid-gas separation mechanism to remove residual hydrogen in the CO—CH₄ mixture in the H₂-depleted second gas stream.

The CO/CH₄ separation section is arranged to receive the intermediate stream from said hydrogen stripper unit and separate it into at least a methane stream and a CO-rich stream. The CO/CH₄ separation section uses low temperature liquid-gas separation mechanism to separate CO from CH₄ in the intermediate stream.

In a CO cold box, substantially pure CH₄ is produced from the CO/CH₄ separation column. This is partly used to wash the synthesis gas in the first column and by doing so the liquid methane is pumped to a pressure slightly higher than the feed pressure to the cold box. Part of this methane is however subtracted from this loop to manage the overall mass balance. This is expanded and mixed with off gas from the hydrogen stripper and then used for feed cooling. In the current invention, a synergy is found in subtracting the liquid methane at high pressure and not mixing with the off gas. Leaving the methane at high pressure while still heat exchanging with the feed will mean that the overall duty of the cold box will increase slightly, but the overall feed consumption of the entire reforming plant will decrease if the methane is returned to the fuel side of the plant.

Further information on a CO cold box using the combination of a methane wash unit, a hydrogen stripper unit, and a CO/CH₄ separation section can be found in Industrial Gases Processing, edited by H.-W. Häring, Wiley-VCH Verlag, 2008.

In another embodiment, the refrigerated separation section comprises a cryogenic CO₂ separation section, the by-product stream is a CO₂-rich stream, and the product stream is a CO₂-depleted syngas. In this embodiment, the plant/process comprises an ASU, a reformer section, and a separation with a cryogenic CO₂ separation section. In this case, the cryogenic CO₂ separation section is arranged to be cooled by at least a portion of the third refrigerant stream from the ASU. In this way the CO₂ separation section can supply pressurized CO₂-lean syngas and pressurized CO₂, where typically the CO₂ would be expanded.

A cryogenic CO₂ separation section typically comprises a first cooling stage of the synthesis gas, followed by cryogenic flash separation unit to separate the liquid condensate from the gas phase. Cooling for the first cooling stage may be provided by the resulting product from the cryogenic flash separation unit, potentially in the combination with other coolants. Optionally, one or more of the products from the CO₂ removal section may be expanded to some extent to make a colder process gas for this cooling stage. Cryogenic separation of CO₂ must be facilitated at elevated pressure, at least above the triple point of CO₂ to allows condensation of CO₂. A suitable pressure regime is therefore at least above the triple point of 5 bar, where increased pressure gives increased liquid yields.

Suitably, the cryogenic CO₂ separation section is operated at a temperature of from ca. −30°° C. to −80° C., depending on the pressure utilised. In an embodiment of the invention, the amount of CO₂ condensed in the cryogenic separation is increased by reducing the operation temperature.

In an embodiment, the cryogenic CO₂ separation section comprises a cooling unit, followed by a flash separation unit, followed by a heating unit. In an embodiment, the cryogenic CO₂ separation section comprises a gas dryer unit. Preferably, the gas dryer unit is the first unit of the cryogenic CO₂ separation section.

In a particular embodiment the plant is arranged to recycle the CO₂-rich by-product stream from the cryogenic CO₂ separation section to the reformer section as feed or to the hydrocarbon feed. Such a separation of CO₂ from the dried first syngas stream and recycling of the separated CO₂-rich by-product stream has provided a possibility of producing a syngas with a lower H₂/CO ratio.

A further embodiment includes an ASU, a reformer section, and a separation with a cryogenic CO₂ separation, and a CO cold box. In this case, therefore, the refrigerated separation section comprises a cryogenic CO₂ separation section and a CO cold box. The cryogenic CO₂ separation section is arranged to receive at least a portion of said dried first syngas stream and provide a CO₂-rich stream and a CO₂-depleted syngas. The CO cold box is arranged to receive at least a portion of a CO₂-depleted syngas from the cryogenic CO₂ separation section and separate it into a CO-rich stream, and a H₂-rich stream.

In this embodiment, at least a portion of the third refrigerant stream from the ASU may be used to first cool the CO cold box and subsequently cool the cryogenic CO₂ separation section. This arrangement makes best use of the cooling power of the refrigerant stream, as the cooling requirement is greater for the CO cold box than the cryogenic CO₂ separation section. For instance, water removal requires temperatures of ca. −40° C., CO₂ separation requires temperatures of ca. −50° C., and CO separation requires temperatures of ca. −160° C., depending on the pressure utilised.

### Ammonia Plant

The plant may be supplemented with additional units/sections, enabling ammonia synthesis. In one aspect, therefore, the plant may further comprise a nitrogen wash unit and an ammonia loop. The nitrogen wash unit is arranged to receive the CO₂-depleted syngas and provide a nitrogen-enriched stream. The ammonia loop is arranged to receive the nitrogen-enriched stream from the nitrogen wash unit and provide an ammonia product stream.

The nitrogen wash unit operates by feeding raw hydrogen into the bottom of the nitrogen wash unit and high-pressure nitrogen into the top of the wash unit. Both streams are cooled down against the product gas, and any trace impurities, such as methane, argon and carbon monoxide, are then removed and recycled as fuel gas. Finally, high pressure nitrogen is added to the process stream to achieve the perfect balance of hydrogen and nitrogen.

The plant according to this aspect is particularly suited to ammonia synthesis, as a ready supply of cooled nitrogen is available. Therefore, at least a portion of the third refrigerant stream from the ASU may also be arranged to be fed to the nitrogen wash unit, where it functions both as coolant and also a source of nitrogen. Alternatively, or additionally, at least a portion of the third refrigerant stream may also be arranged to be fed to the ammonia loop.

Suitably, the ammonia loop comprises an ammonia separation section, and at least a portion of the third refrigerant stream is arranged to cool said ammonia separation section.

A process is also provided for producing a product stream in the chemical plant described herein. The process generally comprises the steps of:
providing a chemical plant as described herein;
supplying the first feed of atmospheric air to the ASU and producing a second stream comprising oxygen and a third refrigerant stream;
supplying at least a portion of the hydrocarbon feed to said reformer section and converting it to a first syngas stream;
supplying at least a portion of the first syngas stream to said water-removal section and providing a water-rich stream and a dried first syngas stream;
supplying at least a portion of said dried first syngas stream to the refrigerated separation section and separating it into at least a product stream and a by-product stream;
cooling the refrigerated separation section using at least a portion of the third refrigerant stream from the ASU.

The product stream may be a H₂-rich stream or a CO₂-depleted syngas, depending on the nature of the refrigerated separation section. All details provided above regarding the plant are equally valid for the process of the invention, mutatis mutandis. In particular, the CO₂-rich stream may be in liquid form at the outlet of the cryogenic CO₂ separation section. This allows subsequent compression steps to be reduced or avoided.

Also, the process includes the following embodiments:
the refrigerated separation section comprises a CO cold box, and wherein the by-product stream is a CO-rich stream, the product stream is a H₂-rich stream, and wherein the CO cold box is cooled by at least a portion of the third refrigerant stream from the ASU;
the refrigerated separation section comprises a cryogenic CO₂ separation section, and wherein the by-product stream is a CO₂-rich stream, the product stream is a CO₂-depleted syngas, and wherein the cryogenic CO₂ separation section is cooled by at least a portion of the third refrigerant stream from the ASU;
the refrigerated separation section comprises a cryogenic CO₂ separation section and a CO cold box, wherein the cryogenic CO₂ separation section receives at least a portion of said dried first syngas stream and provides a CO₂-rich stream and a CO₂-depleted syngas; and wherein the CO cold box receives at least a portion of a CO₂-depleted syngas from the cryogenic CO₂ separation section and separates it into a CO-rich stream, and a H₂-rich stream.

In particular, processes are provided in which at least a portion of the second stream comprising oxygen is also supplied to the reformer section.

A further embodiment is provided, in which the chemical plant does not comprise an ASU.

In such an embodiment, a CO cold box or a cryogenic CO₂ separation unit may serve as the unit providing a refrigerant instead of the ASU. In this embodiment, the chemical plant therefore comprises:
a reformer section, and
a water-removal section
a first refrigerated separation unit
a second refrigerated separation unit
a first feed of atmospheric air,
a hydrocarbon feed,
wherein said first refrigerated separation unit is arranged to produce a refrigerant stream;
wherein said reformer section is arranged to receive at least a portion of the hydrocarbon feed and convert it to a first syngas stream;
wherein said water-removal section is arranged to receive at least a portion of the first syngas stream and provide a water-rich stream and a dried first syngas stream;
wherein said first refrigerated separation unit is arranged to receive at least a portion of said dried first syngas stream and separate it into at least a product stream, and a by-product stream;
and wherein the first refrigerated separation unit is cooled by at least a portion of the refrigerant stream from the second refrigerated separation unit.

In this particular embodiment, the first refrigerated separation section may be a cryogenic CO₂ separation unit and the second refrigerated separation section may be a CO cold box. In an embodiment, wherein the by-product stream from the cryogenic CO₂ separation unit is a CO₂-rich stream, and the product stream from the cryogenic CO₂ separation unit is a CO₂-depleted syngas, and the CO₂-rich by-product stream from the cryogenic CO₂ separation unit is recycled to the reformer section as feed or to the hydrocarbon feed.

As for the first embodiment, the reformer section in this plant may be arranged to receive at least a portion of the second stream comprising oxygen and the hydrocarbon feed and convert them to a first syngas stream.

### Specific Embodiments

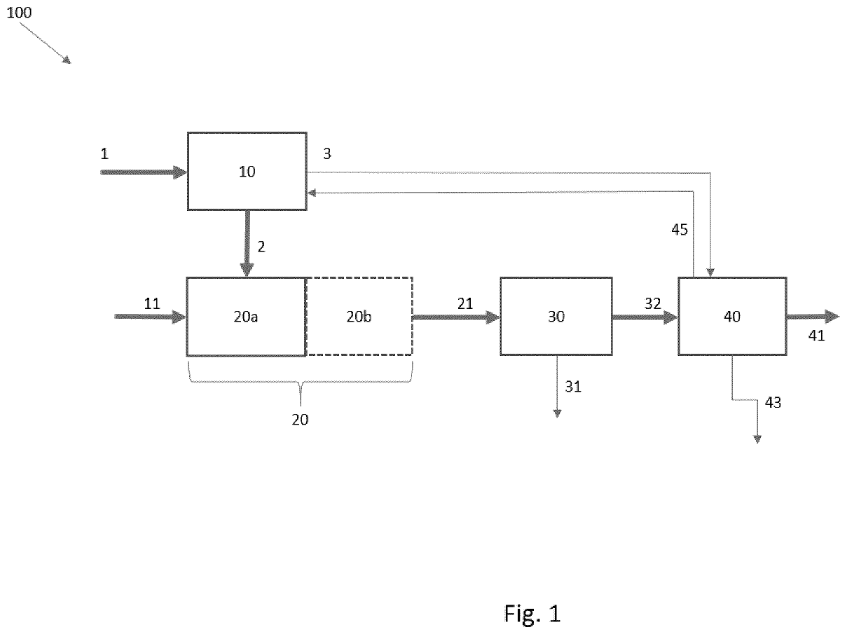

FIG. 1 shows a basic layout of the chemical plant 100 of the invention. First feed 1 of atmospheric air is fed to cryogenic air separation section (ASU, 10), where it is separated into a second stream 2 comprising oxygen and a third refrigerant stream 3. Hydrocarbon feed 11 is fed to reformer section 20—optionally in the presence of second stream 2 comprising oxygen, or an external stream of oxygen, and/or a stream of steam-where it is converted to a first syngas stream 21. In the embodiment illustrated in FIG. 1, the reformer section 20 comprises a primary reformer 20a and shift conversion unit 20b.

The first syngas stream 21 is fed to water-removal section 30, where a water-rich stream 31 and a dried first syngas stream 32 are provided. Removal of water at this stage ensures that it does not condense or freeze out in subsequent steps.

The dried first syngas stream 32 is fed to refrigerated separation section 40, where it is separated it into at least a product stream 41 and a by-product stream 43. As noted, the refrigerated separation section 40 is cooled by the third refrigerant stream 3 from the ASU 10. After cooling the separation section 40, the refrigerant stream maybe returned to the ASU as stream 45.

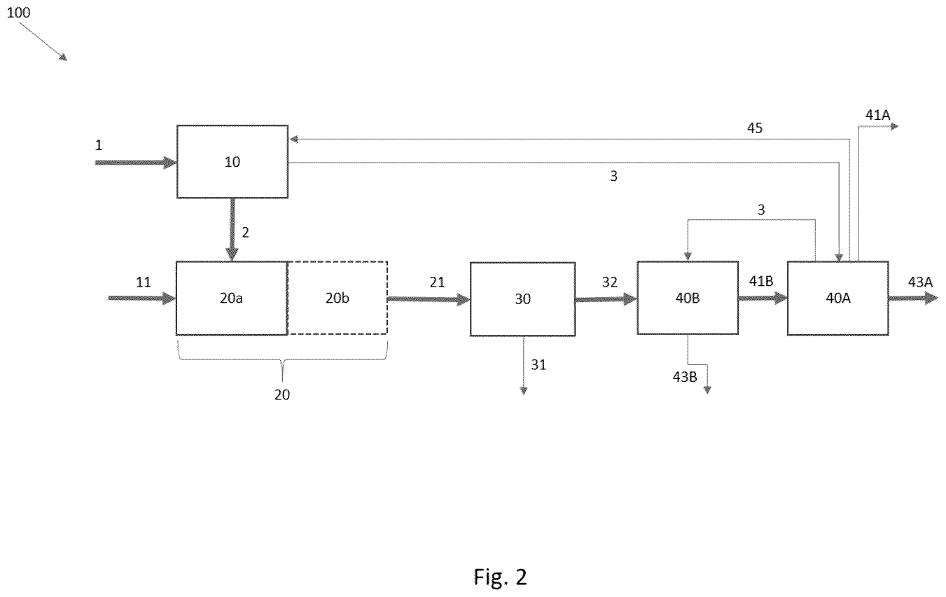

FIG. 2 shows a more advanced layout of the plant of the invention. Components of this layout correspond to those of FIG. 1, plus additional details of the refrigerated separation section 40. In FIG. 2, the refrigerated separation section comprises a cryogenic CO₂ separation section 40B and a CO cold box 40A. The cryogenic CO₂ separation section 40B is arranged upstream the CO cold box 40A. Therefore, dried first syngas stream 32 is first fed to the cryogenic CO₂ separation section 40B, where a CO₂-rich stream 43B and a CO₂-depleted syngas 41B are provided. The CO₂-depleted syngas 41B from the cryogenic CO₂ separation section 40B is fed to CO cold box 40A, where it is separated into a CO-rich stream 43A, and a H2-rich stream 41A.

In the layout of FIG. 2, the third refrigerant stream 3 from the ASU 10 first cools the CO cold box 40A and subsequently cools the cryogenic CO₂ separation section 40B. As for the layout of FIG. 1, the refrigerant stream maybe returned to the ASU as stream 45, after cooling CO cold box 40A.

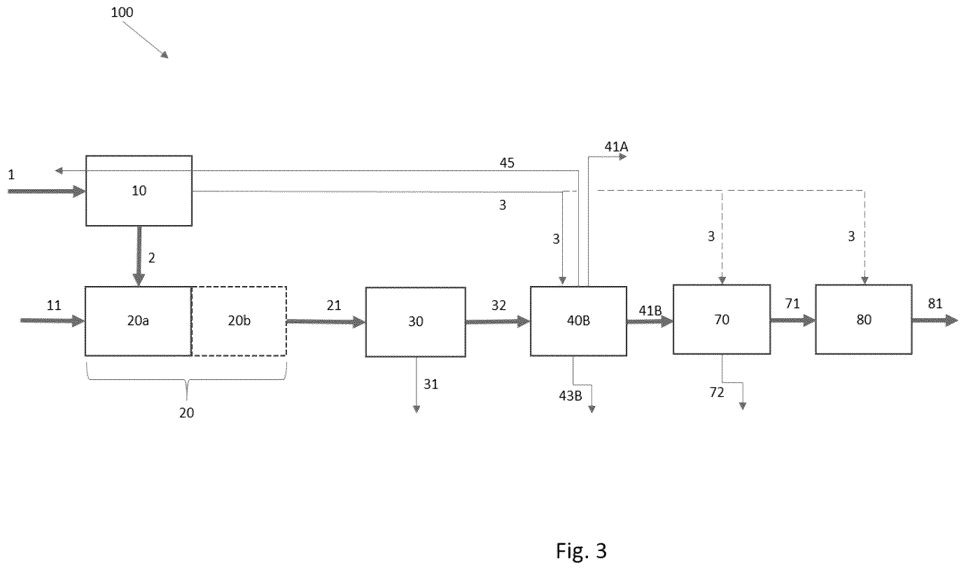

FIG. 3 is a development of the embodiment of FIG. 2. Components of this layout correspond to those of FIG. 2, plus nitrogen wash unit 70 and ammonia loop 80. The CO₂-depleted syngas 41B from the layout of FIG. 2 is fed to the nitrogen wash unit 70, where a nitrogen-enriched stream 71 and a nitrogen-depleted stream 72 are produced. The nitrogen-enriched stream 71 from the nitrogen wash unit 70 is fed to ammonia loop 80, where an ammonia product stream 81 is produced.

As can be seen in FIG. 3, the third refrigerant stream 3 may be fed to any or all of CO cold box 40A, nitrogen wash unit 70 and ammonia loop 80. Preferably, the third refrigerant stream 3 is fed to the nitrogen wash unit 70 where it can function both as coolant and also a source of nitrogen.

The present invention has been described with reference to a number of embodiments and figures. However, the skilled person is able to select and combine various embodiments within the scope of the invention, which is defined by the appended claims. All documents referenced herein are incorporated by reference.

1. A chemical plant comprising:
a cryogenic air separation section,
a reformer section, and
a water-removal section
a refrigerated separation section
a first feed of atmospheric air,
a hydrocarbon feed,
wherein said ASU is arranged to receive said first feed of atmospheric air and produce a second stream comprising oxygen and a third refrigerant stream;
wherein said reformer section is arranged to receive at least a portion of said hydrocarbon feed and convert it to a first syngas stream;
wherein said water-removal section is arranged to receive at least a portion of the first syngas stream and provide a water-rich stream and a dried first syngas stream;
wherein said refrigerated separation section is arranged to receive at least a portion of said dried first syngas stream and separate it into at least a product stream, and a by-product stream;
and wherein the refrigerated separation section is cooled by at least a portion of the third refrigerant stream from the ASU.

2. The plant according to claim 1, wherein said reformer section is arranged to receive at least a portion of the second stream comprising oxygen and said hydrocarbon feed and convert them to a first syngas stream.

3. The plant according to claim 1 wherein the refrigerated separation section comprises a CO cold box and/or a cryogenic CO2 separation unit.

4. The plant according to claim 1, wherein the refrigerated separation section comprises a CO cold box, and wherein the by-product stream is a CO-rich stream, the product stream is a H2-rich stream, and wherein the CO cold box is arranged to be cooled by at least a portion of the third refrigerant stream from the ASU.

5. The plant according to claim 1, wherein the refrigerated separation section comprises a cryogenic CO2 separation section, and wherein the by-product stream is a CO2-rich stream, the product stream is a CO2-depleted syngas, and wherein the cryogenic CO2 separation section is arranged to be cooled by at least a portion of the third refrigerant stream from the ASU.

6. The plant according to claim 5, wherein the plant is arranged to recycle the CO2-rich by-product stream from the cryogenic CO2 separation section to the reformer section as feed or to the hydrocarbon feed.

7. The plant according to claim 1, wherein the refrigerated separation section comprises a cryogenic CO2 separation section and a CO cold box, wherein the cryogenic CO2 separation section is arranged to receive at least a portion of said dried first syngas stream and provide a CO2-rich stream and a CO2-depleted syngas; and wherein the CO cold box is arranged to receive at least a portion of a CO2-depleted syngas from the cryogenic CO2 separation section and separate it into a CO-rich stream, and a H2-rich stream.

8. The plant according to claim 7, wherein at least a portion of the third refrigerant stream from the ASU is arranged to first cool the CO cold box and subsequently cool the cryogenic CO2 separation section.

9. The plant according to claim 1, wherein the third refrigerant stream is a nitrogen stream.

10. The plant according to claim 1, wherein the reformer section comprises one or more primary reformers selected from a steam methane reforming reactor, an electrically heated steam methane reformer, and and an autothermal reforming reactor.

11. The plant according to claim 1, wherein the reformer section comprises a primary reformer and a shift conversion unit arranged downstream the primary reformer.

12. The plant according to claim 5, wherein the refrigerated separation section comprises a cryogenic CO2 separation section, said plant further comprising a nitrogen wash unit arranged to receive the CO2-depleted syngas and provide a nitrogen-enriched stream, said plant further comprising an ammonia loop arranged to receive the nitrogen-enriched stream from said nitrogen wash unit and provide an ammonia product stream.

13. The plant according to claim 12, wherein at least a portion of the third refrigerant stream is fed to the nitrogen wash unit.

14. The plant according to claim 12, wherein said ammonia loop comprises an ammonia separation section, and wherein at least a portion of the third refrigerant stream is arranged to cool said ammonia separation section.

15. A process for producing a product stream in a chemical plant according to claim 1, said process comprising:
providing the chemical plant;
supplying the first feed of atmospheric air to the ASU and producing a second stream comprising oxygen and a third refrigerant stream;
supplying at least a portion of the hydrocarbon feed to the reformer section and converting them to a first syngas stream;
supplying at least a portion of the first syngas stream to the water-removal section and providing a water-rich stream and a dried first syngas stream;
supplying at least a portion of said dried first syngas stream to the refrigerated separation section and separating it into at least a product stream, and a by-product stream;
cooling the refrigerated separation section by at least a portion of the third stream comprising a refrigerant from the ASU.

16. The process according to claim 15, wherein at least a portion of the second stream comprising oxygen is supplied to the reformer section.

17. The process according to claim 15, wherein the CO2-rich stream is in liquid form at the outlet of the cryogenic CO2 separation section.

18. A chemical plant comprising:
a reformer section, and
a water-removal section
a first refrigerated separation unit
a second refrigerated separation unit
a first feed of atmospheric air,
a hydrocarbon feed,
wherein said first refrigerated separation unit is arranged to produce a refrigerant stream;
wherein said reformer section is arranged to receive at least a portion of the hydrocarbon feed and convert them to a first syngas stream;
wherein said water-removal section is arranged to receive at least a portion of the first syngas stream and provide a water-rich stream and a dried first syngas stream;
wherein said first refrigerated separation unit is arranged to receive at least a portion of said dried first syngas stream and separate it into at least a product stream, and a by-product stream; and
wherein the first refrigerated separation unit is cooled by at least a portion of the refrigerant stream from the second refrigerated separation unit.

19. The plant according to claim 18, wherein said reformer section is arranged to receive at least a portion of the second stream comprising oxygen and said hydrocarbon feed and convert them to a first syngas stream.

20. The chemical plant according to claim 18, wherein the first refrigerated separation section is a cryogenic CO2 separation unit and wherein the second refrigerated separation section is a CO cold box.

21. The chemical plant according to claim 20, wherein the by-product stream from the cryogenic CO2 separation unit is a CO2-rich stream, and the product stream from the cryogenic CO2 separation unit is a CO2-depleted syngas, and wherein the CO₂-rich by-product stream from the cryogenic CO₂ separation unit is recycled to the reformer section as feed or to the hydrocarbon feed.
